(19) United States
(12) Patent Application Publication
(10) Pub. No.: US 2013/0332279 A1
(43) Pub. Date: Dec. 12, 2013

(54) METHOD AND APPARATUS FOR LOCATION-BASED ADVERTISEMENTS FOR DYNAMIC POINTS OF INTEREST

(71) Applicants: Juha Harri Tapio Kuusela, Espoo (FI); Ari Antero Aarnio, Espoo (FI); Roope Tapio Takala, Espoo (FI); Janne Joonas Itaranta, Helsinki (FI)

(72) Inventors: Juha Harri Tapio Kuusela, Espoo (FI); Ari Antero Aarnio, Espoo (FI); Roope Tapio Takala, Espoo (FI); Janne Joonas Itaranta, Helsinki (FI)

(73) Assignee: Nokia Corporation, Espoo (FI)

(21) Appl. No.: 13/491,048

(22) Filed: Jun. 7, 2012

(51) Int. Cl. G06Q 30/02

(52) U.S. Cl. 705/14.57

(57) ABSTRACT

An approach is provided for advertising up-to-date information for dynamic points of interest. A point-of-interest platform causes, at least in part, an activation or a deactivation of at least one point-of-interest record. The point-of-interest platform then determines whether to cause, at least in part, a generation of the at least one point-of-interest record based, at least in part, on the activation or the deactivation.

### BACKGROUND

Service providers and device manufacturers (e.g., wireless, cellular, etc.) are continually challenged to deliver value and convenience to consumers by, for example, providing compelling network services. One area of interest has been the development of location-based services (e.g., mapping and/or navigation applications) that can provide users of mobile devices (e.g., mobile phones or tablets) with interesting and relevant information associated with points of interest (POIs) in a particular location (e.g., contact information, hours of operation, geo-coordinates, goods and/or services offered, customer reviews, icon, etc.). However, POI information is generally associated with fixed geo-coordinates (e.g., the location of a store, a restaurant, a theater, etc.), which does not support other commercial enterprises such as street vendors, pop-up stores, or other mobile entrepreneurs that do not have a fixed location or fixed hours of operation. Accordingly, service providers and device manufacturers face significant technical challenges in providing a service that allows mobile entrepreneurs to advertise interesting and relevant POI information about their mobile enterprises.

### SOME EXAMPLE EMBODIMENTS

Therefore, there is a need for an approach for advertising up-to-date information for dynamic points of interest.

According to one embodiment, a method comprises causing, at least in part, an activation or a deactivation of at least one point-of-interest record. The method also comprises determining whether to cause, at least in part, a generation of the at least one point-of-interest record based, at least in part, on the activation or the deactivation.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an activation or a deactivation of at least one point-of-interest record. The apparatus is also caused to determine whether to cause, at least in part, a generation of the at least one point-of-interest record based, at least in part, on the activation or the deactivation.

According to another embodiment, a computer-readable storage medium carries one or more sequences of one or more instructions which, when executed by one or more processors, cause, at least in part, an apparatus to cause, at least in part, an activation or a deactivation of at least one point-of-interest record. The apparatus is also caused to determine whether to cause, at least in part, a generation of the at least one point-of-interest record based, at least in part, on the activation or the deactivation.

According to another embodiment, an apparatus comprises means for causing, at least in part, an activation or a deactivation of at least one point-of-interest record. The apparatus also comprises means for determining whether to cause, at least in part, a generation of the at least one point-of-interest record based, at least in part, on the activation or the deactivation.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-31, and 48-50.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of advertising up-to-date information for dynamic points of interest, according to one embodiment;

FIG. 2 is a diagram of the components of a point-of-interest platform, according to one embodiment;

FIGS. 3 and 4 are flowcharts of a process for advertising up-to-date information for dynamic points of interest, according to one embodiment;

FIG. 5 is a diagram of an example data flow as utilized in the processes of FIGS. 3 and 4, according to various embodiments;

FIG. 6 is a diagram of example user interfaces utilized in the processes of FIGS. 3 and 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for advertising up-to-date information for dynamic points of interest are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

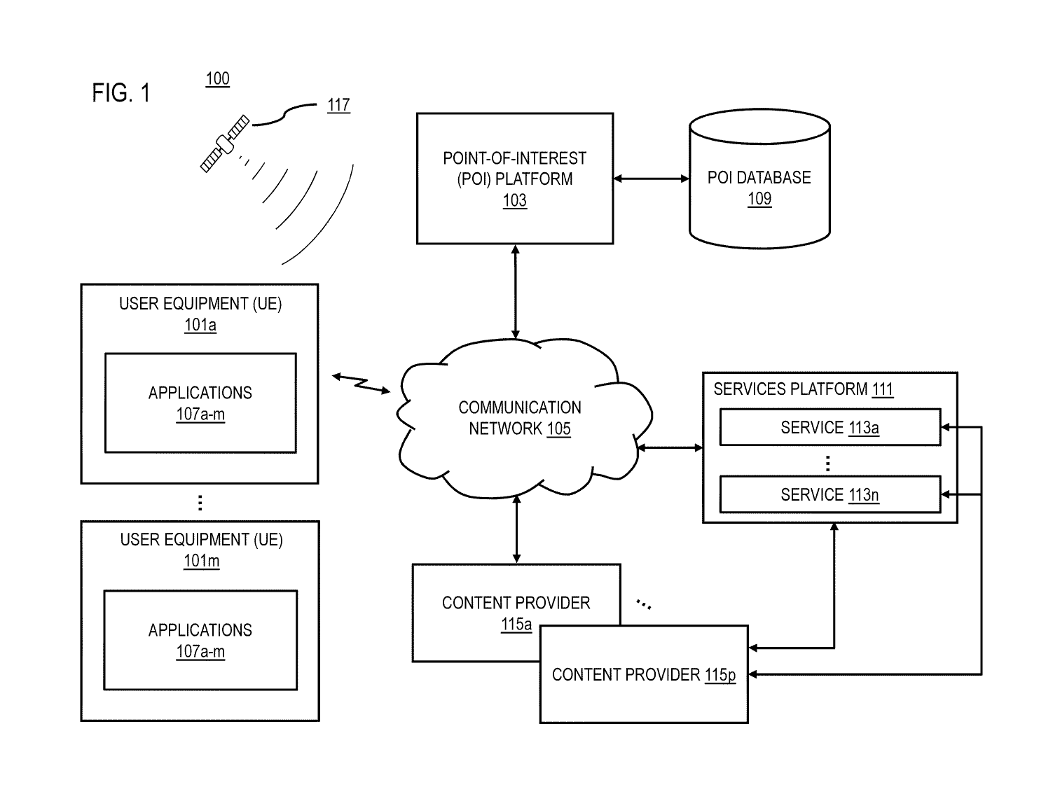

FIG. 1 is a diagram of a system capable of advertising up-to-date information for dynamic points of interest, according to one embodiment. As previously discussed, one area of interest among service providers and device manufactures has been the development of location-based services (e.g., mapping and/or navigation applications) that can provide users of mobile devices (e.g., mobile phones or tablets) with interesting and relevant information associated with POIs in a particular location (e.g., name, contact information, hours of operation, geo-coordinates, goods and/or services offered, customer reviews, icon, etc.). However, POI information is generally associated with fixed geo-coordinates (e.g., the location of a store, a restaurant, a theater, etc.), which does not support other commercial enterprises such as street vendors, pop-up stores, or mobile entrepreneurs that do not have a fixed location or fixed hours of operation. By way of example, a local fisherman may want to sell his excess catch to local residents and tourists alike, but the amount of fish or the type of fish available at a particular time may be difficult to predict. Moreover, the fisherman may need to fish different locations at different times throughout the day to catch sufficient numbers of fish to offer to customers. Accordingly, current POI information system would not help customers find the fisherman or his fresh fish.

To address this problem, a system 100 of FIG. 1 introduces the capability of advertising up-to-date information for dynamic points of interest. In one embodiment, the system 100 first determines one or more rules or a trigger for causing an activation (e.g., an advertising, a broadcasting, a making visible, a making searchable, etc.) or a deactivation of at least one point-of-interest record (e.g., a name, contact information, hours of operation, geo-coordinates, goods and/or services offered, customer reviews, icon, etc.) on a mapping and/or navigation application, for example. In particular, it is contemplated that a point of interest is associated with at least one mobile device (e.g., a mobile phone or a tablet). Further, the one or more rules specify that the activation or the deactivation of the at least one point-of-interest record is based, at least in part, on one or more temporal parameters, one or more location parameters, one or more environmental parameters (e.g., current or future weather conditions), or a combination thereof. More specifically, the one or more temporal parameters include, at least in part, one or more operating times (e.g., hours of operation), one or more availability times (e.g., pre-broadcasting the hours of operation an hour or two before the actual opening and/or closing of the POI), one or more reservation times (e.g., where one or more vendors offer their goods and/or services at one or more predefined locations, at a particular time), or a combination thereof. The one or more operating times and/or the one or more availability times may also be temporary depending on the various other criteria associated with the rules (e.g., an availability of goods to sell, customers, etc.). Moreover, the one or more location parameters include, at least in part, one or more locations, one or more routes presenting the at least one point-of-interest record (e.g., a predicted route based on general speeds of movement, a proximate location algorithm, a statistical model, etc.), one or more predefined locations (e.g., where a municipality or an owner of realty offers one or more vendors the ability to reserve or book space to offer their goods and/or services), or a combination thereof. In particular, the one or more locations are determined by the system 100 based, at least in part, on one or more location-based technologies associated with the at least one mobile device corresponding to a particular POI (e.g., global positioning system (GPS) receivers, cellular triangulation, Assisted GPS (A-GPS), etc.). The one or more location parameters and the one or more routes may also be temporary depending on the various other criteria associated with the rules (e.g., an availability of goods to sell, customers, etc.). It is also contemplated that the system 100 may determine one or more rules based on any additional criteria for determining when, where, and under what conditions a particular point-of-interest record should be activated or deactivated.

In one embodiment, the primary manner in which the system 100 determines the one or more rules, the at least one point-of-interest record, or a combination thereof is by determining an input from one or more vendors. By way of example, a vendor may use a user interface (e.g., a web client, a widget, an application, etc.) of the at least one mobile device (e.g., a mobile phone or a tablet) to specify the one or more rules. The system 100 can then determine the one or more rules based on a unique ID associated with the point of interest, the at least one mobile device, or a combination thereof, which is stored in a centralized point-of-interest database. In particular, the one or more rules may include one or more instructions to activate the POI record an hour before opening of the point of interest and to deactivate the POI record at closing; to deactivate the POI record when all of the goods have been sold; to change the icon, color, or transparency of the POI record on a mapping and/or navigation application for some time after the point of interest has closed; to deactivate the POI record in the rain; etc. More specifically, the vendor may use the user interface to advertise or broadcast that “Vendor ‘A’ will be at location ‘X’ at ‘Y’ time.” In addition, the vendor may pre-broadcast a location and hours of operation and/or may advertise the location and hours of operation of the point of interest while moving throughout a particular area (i.e., enabling a substantially real-time tracking feature). Moreover, the vendor may use the user interface of the at least one mobile device to input quantitative and qualitative data regarding his or her offerings (e.g., “Vendor ‘A’ is selling I′, ‘M’, and ‘N’ fish at ‘X’ location, at ‘Y’ time, but there are only two fish remaining of each type”). In another example use case, the vendor may establish a rule that associates the point-of-interest record with a personal calendar or a status update on a social networking site that includes the anticipated locations and hours of operation of the POI. Further, the vendor also may use the user interface to emphasize an availability of discounts associated with a point-of-interest record based, at least in part, on having excess goods (e.g., excess fish) and/or capacity (e.g., too few customers at a pop-up hairdresser).

In addition, in one or more embodiments, the municipality or another owner of realty may enable a vendor to reserve or book a particular POI, with or without charge (e.g., location “X” from 12 pm to 1 pm and location “Z” from 2 pm to 4 pm). By way of example, the vendor can pay electronically for the activation of the POI. More specifically, this can be implemented by way of “BUY” button on a user interface (UI) of a mobile device (e.g., a mobile phone or a tablet) and the payment method can be based on any number of electronic payment methods. As a result, the system 100 can more effectively control the POI activation process.

In certain embodiments, the vendor may communicate his or her offerings using, for example, wireless LAN (WLAN), Bluetooth, or other local radio connection between peers under radio coverage. A customer that receives an advertisement can then forward the advertisement to other nearby mobile devices. In one embodiment, one or more mobile devices (e.g., the at least one mobile device) may have previously downloaded a POI app from an App store (e.g., Nokia Store). The one or more mobile devices can then set-up the POIs on the one or more devices and locally share the POI information.

In one embodiment, the system 100 then determines a current state, a predicted state, or a combination thereof of the one or more temporal parameters, the one or more location parameters, the one or more environmental parameters, or a combination thereof, wherein the processing of the rules, the activation or deactivation of the at least one point-of-interest record is based, at least in part, on the current state, the predicted state, or a combination thereof. By way of example, the one or more rules may specify that for a particular POI (e.g., a fisherman on foot) that the point-of-interest record should only be activated for when and where he is actually fishing based on the assumption, for example, that if the fishing is good that day in a particular area, the fisherman is unlikely to leave that area. In contrast, the one or more rules may specify that for another POI (e.g., a street musician) the point-of-interest record should be activated for both when and where he or she is performing as well as for when and where he or she may be performing later in the day based on the assumption, for example, that street musicians have to move around from time to time to maximize available customers. In addition, it is contemplated that the system 100 can search the various point-of-interest records in the centralized point-of-interest database using one or more logics, general speeds of movement, one or more proximate location algorithms, one or more statistical models, etc. to determine one or more predications as to when and where a dynamic POI should be activated (e.g., showing not only open shops, but also shops that might open in the near future). By way of example, the system 100 may predict the route of an ice cream truck traveling through a neighborhood.

Once the system 100 determines the one or more rules for activating or deactivating a point-of-interest record, the system 100 causes, at least in part, an association of the one or more rules with at least one point-of-interest record, wherein the association is specified as at least one field of the at least one point-of-interest record, as metadata associated with the at least one-point-of-interest record, or a combination thereof. As previously discussed, the system 100 may maintain the point-of-interest records in a centralized point-of-interest database. It is contemplated that the association of the one or more rules with the at least one point-of-interest record can enable the system 100 to build into each point-of-interest record a novel level of intelligence or logic (e.g., when, where, and under what conditions to display and/or make available the point-of-interest record).

In one embodiment, based, at least in part, on the one or more rules or triggers, the system 100 causes, at least in part, an activation or a deactivation of the at least one point-of-interest record. As previously discussed, the activation of the at least one point-of-interest record may include an advertising, a broadcasting, a making visible, a making searchable, etc. of the at least one point-of-interest record in connection with a mapping and/or navigation application, an augmented reality application, a social networking application, etc.

In one or more embodiments, the system 100 next determines whether to cause, at least in part, a generation (e.g., a rendering or a presentation) of the at least one point-of-interest record based, at least in part, on the activation or the deactivation. More specifically, the activation of the at least one point-of-interest record may occur in advance of a request (e.g., as an update of the mapping and/or navigation application), in response to at least one request, or a combination thereof. In addition, the system 100 may take into consideration a potential payment from the one or more vendors to determine a frequency of publication, a degree of search engine optimization, a size or a prominence of a point-of-interest record in a mapping and/or navigation application, for example.

In certain embodiments, the system 100 first determines at least one request (e.g., from a mobile device) for the at least one point-of-interest record. In one example use case, a tourist may be exploring an unfamiliar area using a mapping and/or navigation application on his or her mobile device (e.g., a mobile phone or a tablet) and he or she may want to look for some food and/or for some entertainment. As a result, the tourist may input one or more keywords typically associated with fixed location POIs (e.g., “fresh fish,” “music,” “restaurants,” etc.) into a mobile search engine or a mapping and/or navigation application on his or her mobile device. To ensure relevant results, the system 100 first determines contextual information associated with the one or more devices associated with the at least one request (e.g., the mobile phone of the tourist), one or more points of interest associated with the at least one point-of-interest record (e.g., one or more street vendors), or a combination thereof, wherein the one or more rules, the processing of the one or more rules, or a combination thereof is further based, at least in part, on the contextual information. By way of example, the system 100 may determine both the geographic location and the subject matter of the particular request. For example, if the tourist is hungry for a hotdog or a pretzel, the system 100 can determine the most relevant POIs (e.g., a hot dog stand) in that area, at that time.

In one embodiment, the system 100 then processes and/or facilitates a processing of the one or more rules to determine whether to cause, at least in part, a generation of the at least one point-of-interest record. In addition, the system 100 determines one or more rendering characteristics associated with the generation of the at least one point-of-interest record based, at least in part, on the contextual information, the one or more rules, user input, or a combination thereof. As previously discussed, in addition to presenting the point-of-interest record, the system 100 could also make the point-of-interest record searchable (e.g., in a search engine) without having to make the point-of-interest record visible (e.g., in a mapping and/or navigation application). By way of example, the system 100 may attempt to “match” information associated with a point-of-interest record in the centralized point-of-interest database with the requested information submitted by the user based, at least in part, on one or more rules. If the system 100 determines a “match,” then the system 100 may generate the point-of-interest record (e.g., a name, hours of operation, geo-coordinates, goods and/or services offered, consumer reviews, etc.) on or as part of a mapping and/or navigation application (e.g., as an update to the mapping and/or navigation application), an augmented reality (AR) application, a social networking application, etc. so that a user is readily able to find the requested information. By way of example, the system 100 may generate one or more responsive point-of-interest records as part of a calculated route in the mapping and/or navigation application (e.g., Vendor “A” is selling fish at location “R”, 10 meters away Vendor “B” is selling fish at location “S”, and 20 meters away from location “R”, Vendor “C” is selling fish at location “T”, etc.).

In certain embodiments, where the one or more mobile devices lack a mapping and/or navigation application, for example, the system 100 may advertise the point-of-interest record information via one or more text messaging processes (e.g., short message service (SMS), multimedia messaging service (MMS), or a combination thereof). In one embodiment, the system 100 may determine to present only the most essential point-of-interest record information (e.g., hours of operation, location, and goods and/or services offered) in response to a particular request. Further, in certain embodiments, the system 100 may compare a closing time listed in the point-of-interest record against a device clock (e.g., of the at least one mobile device) to present the one or more POI records responsive to a request, but already closed for the day, as a different icon, color, level of transparency, etc. on the mapping and/or navigation application so that the requesting customer may know to come back to the POI during the hours of operation.

In one embodiment, the presentation of the information associated with a point-of-interest record may occur as part of a scheduled event. For example, in one embodiment, the system 100 may determine one or more subscribing user devices (e.g., a mobile phone or tablet) associated with the at least one point-of-interest record (e.g., as a result of “following” a particular point of interest). As a result, the system 100 may then cause, at least in part, a transmission of the one or more messages associated with the activation or the deactivation of the at least one point-of-interest record to the one or more subscribing devices (e.g., using a social networking service).

As shown in FIG. 1, the system 100 comprises one or more user equipment (UE) 101a-101m (e.g., a mobile phone or a tablet) (also collective referred to as UEs 101) having connectivity to a point-of-interest (POI) platform 103 via a communication network 105. The UEs 101 may include or have access to one or more applications 107a-107m (also collectively referred as applications 107). By way of example, the applications 107 may include, for example, a web client or web browser, a mapping and/or navigation application, a social networking application, one or more organizational applications (e.g., a personal calendar, contacts, etc.).

In one embodiment, the point-of-interest platform 103 may include or be associated with a POI database 109. The point-of-interest platform 103 may exist in whole or in part within the UEs 101, or independently and the POI database 109 may also exist in whole or in part within the point-of-interest platform 103, or independently. The POI database 109 may include the at least one point-of-interest record (e.g., name, contact information, hours of operation, geo-coordinates, goods and/or services offered, customer reviews, icon, etc.) associated with a dynamic point of interest. The POI database 109 may also include the one or more rules, the one or more criteria, or a combination thereof for determining when to activate or deactivate the at least one point-of-interest record. In addition, the POI database 109 also may include a record of the unique IDs associated with the at least one mobile device corresponding to a dynamic point of interest and corresponding point-of-interest record. Further, the POI database 109 may also include subscription information (e.g., one or more credentials) for the one or more subscribing devices associated with the at least one point-of-interest record.

The UEs 101 are also connected to a services platform 111 via the communication network 105. The services platform 111 includes one or more services 113a-113n (also collectively referred to as services 113). The services 113 may include a wide variety of services such as content provisioning services for the one or more applications 107 (e.g., location-based services, social networking services, weather services, etc.). In addition, the UEs 101, the services platform 111, and the services 113 are also connected to one or more content providers 115a-115p (also collectively referred to as content providers 115) via the communication network 105. The content providers 115 also may provision a wide variety of content (e.g., customer reviews, location-based content, etc.) to the components of the system 100.

In certain embodiments, the applications 107 may utilize location-based technologies (e.g., GPS, cellular triangulation, A-GPS, etc.) to input location-based data (e.g., a location of a POI) to the point-of-interest platform 103 and/or make a request to the point-of-interest platform 103 or the one or more services 113 for location-based data (e.g., a location of a POI, mapping and/or navigation information, or a combination thereof) based on a position relative to the UEs 101. For example, a UE 101 may include a GPS receiver to obtain geographic coordinates form the satellites 117 to determine its current location. In addition, the current location of the UEs 101 can be determined by one or more landmark names (e.g., Eiffel Tower, Coliseum, etc.).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, the point-of-interest platform 103 first determines one or more rules or a trigger for causing an activation (e.g., an advertising, a broadcasting, a making visible, a making searchable, etc.) or a deactivation of at least one point-of-interest record (e.g., a name, contact information, hours of operation, geo-coordinates, goods and/or services offered, customer reviews, icon, etc.) on a mapping and/or navigation application, for example. In particular, it is contemplated that a point of interest is associated with at least one UE 101 (e.g., a mobile phone or a tablet). In addition, the one or more rules specify that the activation or the deactivation of the at least one point-of-interest record is based, at least in part, on one or more temporal parameters, one or more location parameters, one or more environmental parameters (e.g., current or future weather conditions), or a combination thereof. As previously discussed, the one or more temporal parameters include, at least in part, one or more operating times (e.g., hours of operation, days of the week, etc.), one or more availability times (e.g., pre-broadcasting the hours of operation), one or more reservation times (e.g., where one or more vendors offer their goods and/or services at one or more predefined locations, at a particular time), or a combination thereof. In addition, the one or more operating times and/or the one or more availability times also may be temporary depending on the various other criteria associated with the rules (e.g., an availability of goods to sell, customers, etc.). Further, the one or more location parameters include, at least in part, one or more locations, one or more routes presenting the at least one point-of-interest record (e.g., a predicted routed), one or more predefined locations (e.g., a reserved space), or a combination thereof. In particular, the point-of-interest platform 103 determines the one or more locations based, at least in part, on one or more location-based technologies associated with the UE 101 corresponding to the POI (e.g., GPS receivers, cellular triangulation, A-GPS, etc.). Again, the one or more location parameters and the one or more routes may also be temporary depending on the various other criteria associated with the rules (e.g., an availability of goods to sell, customers, etc.). It is further contemplated that the point-of-interest platform 103 may also determine the one or more rules based on any additional criteria for determining when, where, and under what conditions a particular point-of-interest record should be activated or deactivated.

In one embodiment, the principle manner in which the point-of-interest platform 103 determines the one or more rules, the at least one point-of-interest record, or a combination thereof is by determining an input from one or more vendors. As previously discussed, a vendor may use a user interface (e.g., an application 107) of a UE 101 (e.g., a mobile phone) associated with the point of interest to specify the one or more rules. More specifically, the point-of-interest platform 103 determines the one or more rules based on a unique ID associated with the point of interest, the UE 101, or a combination thereof, which is stored in the point-of-interest database 109. For example, the one or more rules may include one or more instructions to activate the POI record an hour before the opening of the point of interest and to deactivate the POI record at the closing; to deactivate the POI record when all of the goods have been sold; to change the icon, color, or level of transparency of the POI record on a mapping and/or navigation application for some time after the point of interest has closed; to deactivate the POI record in the rain; etc. More specifically, the vendor may use an application 107 to advertise or broadcast that “Vendor ‘A’ will be at location ‘X’, at ‘Y’ time.” In other example use case, the vendor may use an application 107 to pre-broadcast a location and hours of operation and/or may advertise the location and the hours of operation of the POI while moving throughout a particular area (i.e., enabling a substantially real-time tracking feature). In addition, the vendor may use an application 107 to input quantitative and qualitative data regarding his or her offerings. Further, the vendor may use an application 107 to establish a rule that associates the point-of-interest record with one or more applications 107 (e.g., a personal calendar or social networking application) that include the anticipated locations and hours of operation of the POI.

In one or more embodiments, the municipality or another owner of realty may enable a vendor to reserve or book a particular POI, with or without charge (e.g., location “X” from 12 pm to 1 pm and location “Z” from 2 pm to 4 pm). By way of example, the vendor can pay electronically for the activation of the POI. In particular, this can be implemented by way of “BUY” button on a user interface (UI) of the at least one mobile device (e.g., the UE 101) and the payment method can be based on any number of electronic payment methods. As a result, the point-of-interest platform 103 can more effectively control the POI activation process.

In certain embodiments, the point-of-interest platform 103 then determines a current state, a predicted state, or a combination thereof of the one or more temporal parameters, the one or more location parameters (e.g., whether the POI is within walking distance, cycling distance, etc.), the one or more environmental parameters, or a combination thereof, wherein the processing of the one or more rules, the activation or deactivation of the at least one point-of-interest record is based, at least in part, on the current state, the predicted state, or a combination thereof. As previously discussed, it is contemplated that the point-of-interest platform 103 can search various point-of-interest records in the POI database 109 using one or more logics, general speeds of movement, one or more proximate location algorithms, one or more statistical models, etc. to determine one or more predictions as to when and where a dynamic POI should be activated (e.g., showing not only open shops, but also shops that might open in the near future).

Once the point-of-interest platform 103 determines the one or more rules for activating or deactivating a point-of-interest record, the point-of-interest platform 103 causes, at least in part, an association of the one or more rules with at least one point-of-interest record, wherein the association is specified as at least one field of the at least one point-of-interest record, as metadata associated with the at least one point-of-interest record, or a combination thereof. As previously discussed, it is contemplated that the association of the rules with the at least one point-of-interest record may enable the point-of-interest platform 103 to build into each point-of-interest record a novel level of intelligence or logic (e.g., when, where, and under what conditions to display and/or make available the point-of-interest record).

In one embodiment, based, at least in part, on the one or more rules or triggers, the point-of-interest platform 103 causes, at least in part, an activation or a deactivation of the at least one point-of-interest record. As previously discussed, the activation of the at least one point-of-interest record may include an advertising, a broadcasting, a making visible, a making searchable, etc. of the at least one point-of-interest record in connection with a mapping and/or navigation application (e.g., an application 107), an augmented reality application, a social networking application, etc.

In one or more embodiments, the point-of-interest platform 103 next determines whether to cause, at least in part, a generation (e.g., a rendering or a presentation) of the at least one point-of-interest record based, at least in part, on the activation or the deactivation. More specifically, the activation of the at least one point-of-interest record may occur in advance of a particular request (e.g., as an update of the mapping and/or navigation application), in response to at least one request, or a combination thereof. Moreover, the point-of-interest platform 103 may take into consideration a potential payment from the one or more vendors to determine a frequency of publication, a degree of search engine optimization, a size or a prominence of a point-of-interest record in a mapping and/or navigation application, for example.

In certain embodiments, the point-of-interest platform 103 first determines at least one request (e.g., from a UE 101) for the at least one point-of-interest record. By way of example, the at least one request may include an entry in a mobile search engine or a mapping and/or navigation application looking for a nearby restaurant or entertainment in specified area. To ensure relevant results, the point-of-interest platform 103 first determines contextual information associated with the one or more UEs 101 associated with the request (e.g., a mobile phone of a tourist), one or more points of interest associated with the at least one point-of-interest record (e.g., a pop-up restaurant), or a combination thereof, wherein the one or more rules, the processing of the one or more rules, or a combination thereof is further based, at least in part, on the contextual information. For example, the point-of-interest platform 103 may determine both a geographic location as well as a subject matter of the request to determine the most relevant POIs in that area, at that time. In one embodiment, the user can input a landmark name (e.g., the Eiffel Tower) as a location parameter, capture an image of the location, or tap a tag with location information in the query.

In one embodiment, the point-of-interest platform 103 then processes and/or facilitates a processing of the one or more rules to determine whether to cause, at least in part, a generation of the least one point-of-interest record. In addition, the point-of-interest platform determines one or more rendering characteristics associated with the generation of the at least one point-of-interest record based, at least in part, on the contextual information, the one or more rules, user input, or a combination thereof. As previously discussed, in addition to presenting the at least point-of-interest record, the point-of-interest platform 103 can also make the point-of-interest record searchable (e.g., in a search engine) without having to make the record visible (e.g., in a mapping and/or navigation application). By way of example, the point-of-interest platform 103 may attempt to “match” a point-of-interest record stored in the POI database 109, for example, with the requested information based, at least in part, on one or more rules. If the point-of-interest platform 103 determines a “match,” then the point-of-interest platform 103 may present the point-of-interest record (e.g., a name, hours of operation, geo-coordinates, goods and/or services offered, consumer reviews, icon, etc.) on or as part of a mapping and/or navigation application (e.g., as an update to the mapping and/or navigation application), an augmented reality application, a social networking application, etc. so that a user is readily able to find the requested information. For example, the point-of-interest platform 103 may generate the one or more responsive point-of-interest records as part of a calculated route in the mapping and/or navigation application (e.g., Vendor “A” is selling fish at location “R”, 10 meters away Vendor “B” is selling fish at location “S”, 20 meters away from location “R”, Vendor “C” is selling fish at location “T”, etc.).

In one or more embodiments, where the one or more mobile devices lack a mapping and/or navigation application, for example, the point-of-interest platform 103 may advertise the point-of-interest record information via one or more text messaging processes (e.g., SMS, MMS, or a combination thereof). In addition, in one embodiment, the point-of-interest platform 103 may only present the most essential point-of-interest record information (e.g., hours of operation, location, and goods and/or services offered) in response to a particular request. In another embodiment, the point-of-interest platform 103 may compare the hours of operation in the point-of-interest record against a device clock (e.g., of the UE 101) to present one or more POI records responsive to a request, but already closed for the day, as a different icon, color, level of transparency, etc. so that the requesting customer may know to come back to the POI during hours of operation.

In one embodiment, the activation and/or presentation of the point-of-interest record may occur as part of a scheduled event. For example, the point-of-interest platform 103 may determine one or more subscribing UEs 101 (e.g., a mobile phone) associated with the at least one point-of-interest record (e.g., as a result of “following” a particular point of interest). As a result, the point-of-interest platform 103 may cause, at least in part, a transmission of the one or more messages associated with the activation or deactivation of the least one point-of-interest record to the one or more subscribing UEs 101 (e.g., using the services 113).

By way of example, the UEs 101, the point-of-interest platform 103, the applications 107, the POI database 109, the services platform 111, the services 113, the content providers 115, and the satellites 117 communicate with each other and other components of the communication network 105 using current, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

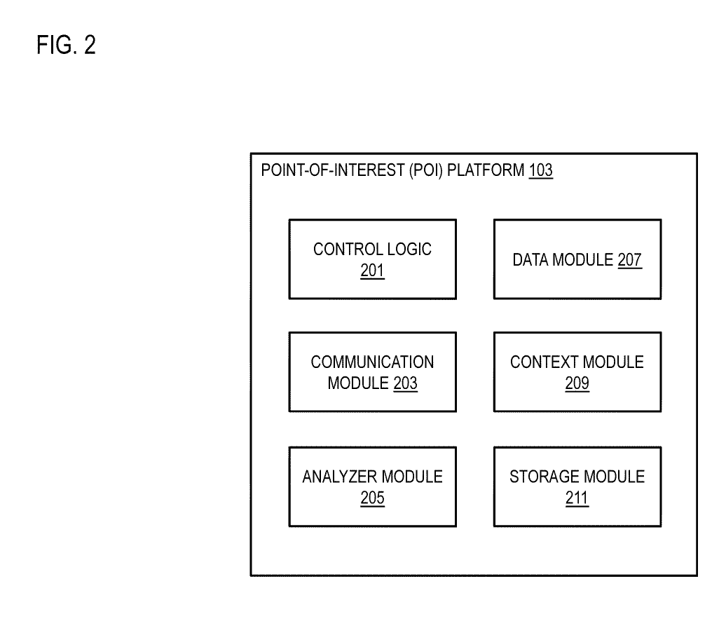

FIG. 2 is a diagram of the components of point-of-interest platform 103, according to one embodiment. By way of example, the point-of-interest platform 103 includes one or more components for providing advertising up-to-date information for dynamic points of interest. It is contemplated that the functions of these components may be combined in one or more components or performed by other components of equivalent functionality. In this embodiment, the point-of-interest platform 103 includes a control logic 201, a communication module 203, an analyzer module 205, a data module 207, a context module 209, a storage module 211.

The control logic 201 oversees tasks, including tasks performed by the communication module 203, the analyzer module 205, the data module 207, the context module 209, the storage module 211. For example, the although other modules may perform the actual task, the control logic 201 may determine when and how those tasks are performed or otherwise direct the other modules to perform the task. In addition, the control logic 201 is used to cause, at least in part, an activation (e.g., an advertising, broadcasting, a making visible, a making searchable, etc.) or a deactivation of at least one point-of-interest record. The control logic 201 may also be used to determine the one or more rules based, at least in part, on a request.

The communication module 203 is used for communication between the UEs 101, the point-of-interest platform 103, the applications 107, the POI database 109, the services platform 111, the services 113, the content providers 115, and the satellites 117. The communication module 203 may also be used to communicate commands, requests, data, etc. In addition, the communication module 203 may be used to determine an input from one or more vendors (e.g., using an application 107 of a UE 101) for specifying the one or more rules, the at least one point-of-interest record, or a combination thereof. The communication module 203 also may be used to determine at least one request (e.g., from an application 107 of a UE 101) for the at least one point-of-interest record. Further, the communication module 203 may be used to cause, at least in part, a transmission of the one or more messages associated with the activation or deactivation of the at least one point-of-interest record to the one or more subscribing user devices.

The analyzer module 205, in connection with the data module 207, is used to determine a current state, a predicted state, or a combination thereof of the one temporal parameters, the one or more location parameters, the one or more environmental parameters, or a combination thereof, wherein the processing of the one or more rules, the activation or the deactivation of point-of-interest record is based, at least in part, on the current state, the predicted state, or a combination thereof. More specifically, it is contemplated that the analyzer module 205 can search the various point-of-interest records in the POI database 109 using one or more logics, one or more algorithms, one or more statistical models, etc. to determine the current state of the one or more parameters, the predicted state of the one or more parameters, or a combination thereof. The analyzer module 205 may also be used to determine whether to cause, at least in part, a generation of the at least one point-of-interest record (e.g., in a mapping and/or navigation application). In addition, the analyzer module 205 also may be used to determine whether to cause, at least in part, a point-of-interest record to become searchable (e.g., in a search engine) in addition to and/or as an alternative to causing, at least in part, a generation of the point-of-interest record. The analyzer module 205 may also be used to determine one or more subscribing user devices associated with the at least one point-of-interest record (e.g., based on one or more credentials stored in the POI database 109). Further, the analyzer module 205 also may be used in connection with the context module 209 to determine one or more rendering characteristics associated with the generation of the at least one point-of-interest record based, at least in part, on the contextual information, the one or more rules, user input, or a combination thereof. More specifically, the analyzer module 205 may be used to compare the closing time in the point-of-interest record against a device clock (e.g., of the at least one mobile device) to determine whether the device clock is already passed the closing time of the point-of-interest record. The data module 207 is used to cause, at least in part, an association of the one or more rules with the at least one point-of-interest record, wherein the association is specified as at least one field of the at least one point-of-interest record, as metadata associated with the at least one point-of-interest record, or a combination thereof. As previously discussed, it is contemplated that the association of the rules with the at least one point-of-interest record may enable the data module 207 to build into each point-of-interest record a novel level of intelligence or logic (e.g., when, where, and under what conditions to display or make available the point-of-interest record).

The context module 209 may be used to determine the geographic context or situation of the UEs 101 by utilizing location-based technologies (e.g., GPS, cellular triangulation, A-GPS, etc.) to determine location-based information regarding the UEs 101. In addition, the context module 209 is used to determine contextual information associated with one or more devices (e.g., a mobile phone or a tablet) associated with at least one request, one or more points of interest associated with at least one point-of-interest record, or a combination thereof, wherein the one or more rules, the processing of the one or more rules, or a combination thereof is further based, at least in part, on the contextual information. In certain embodiments, the context module 209 may be used in connection with the communication module 203 to determine contextual information input directly into the point-of-interest platform 103 by one or more vendors (e.g., using a UE 101). In addition to location, the context module 209 also may be used to determine time associated with the one or more devices (e.g., time based on a device clock).

The storage module 211 is used to manage the storage in the POI database 109 of the at least one point-of-interest record associated with each dynamic point of interest, the one or more rules, the one or more criteria, or a combination thereof for determining when to activate or deactivate the at least one point-of-interest record, the unique ID of the at least one mobile device associated with a dynamic point of interest, and subscription information (e.g., one or more credentials) for the one or more subscribing devices associated with the at least one point-of-interest record.

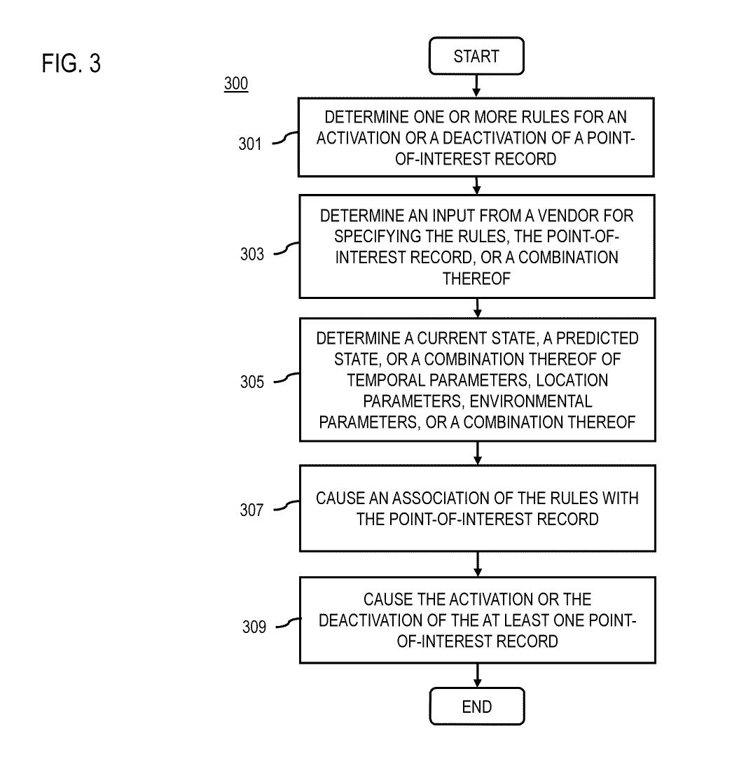

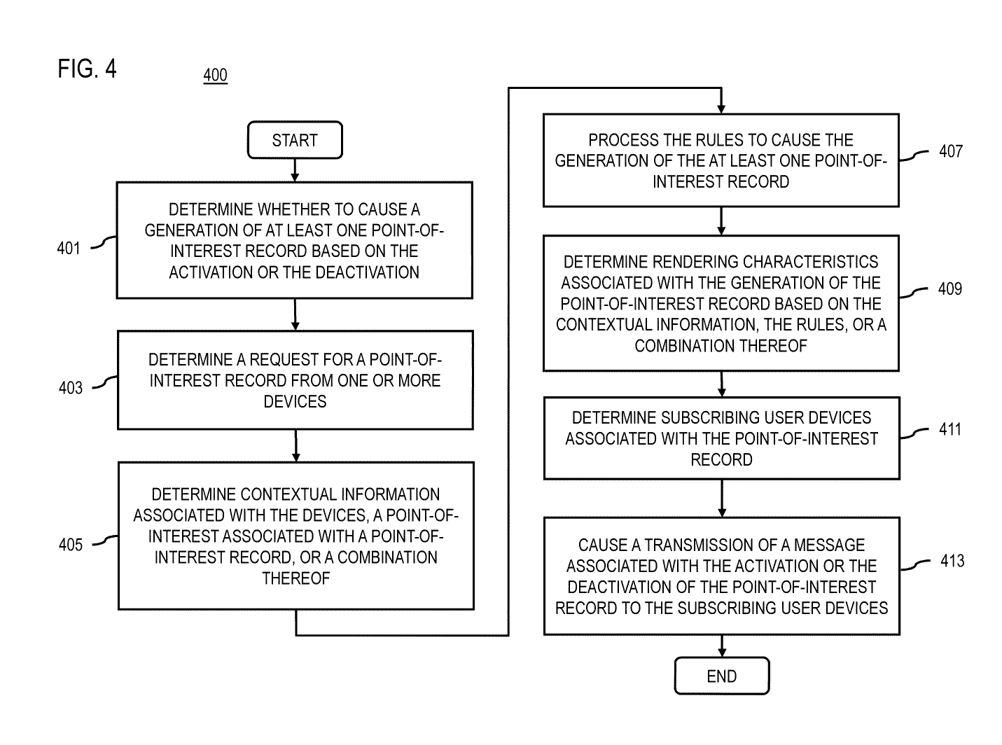

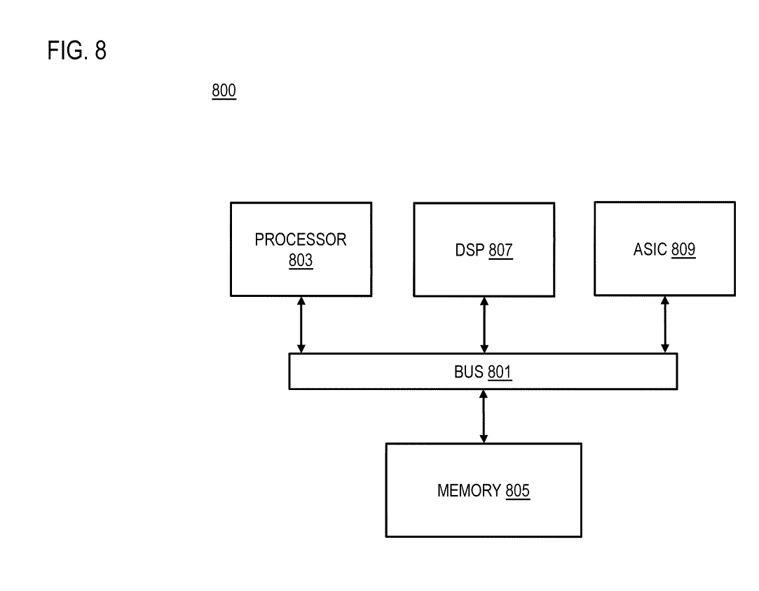

FIGS. 3 and 4 are flowcharts of processes for advertising up-to-date information for dynamic points of interest, according to one embodiment. FIG. 3 depicts a process 300 of determining one or more rules for causing, at least in part, an activation or deactivation of at least one point-of-interest record. In one embodiment, the point-of-interest platform 103 performs the process 300 and is implemented in, for instance, a chip set including a processor and a memory as shown in FIG. 8. In step 301, the point-of-interest platform 103 determines one or more rules for the activation or the deactivation of at least one point-of-interest record. By way of example, the activation of the least one point-of-interest record may include an advertising, a broadcasting, a making visible, a making searchable, etc. of information associated with a point of interest and contained within the point-of-interest record (e.g., a name, contact information, hours of operation, geo-coordinates, goods and/or services offered, customer reviews, icon, etc.). Moreover, the one or more rules specify that the activation or the deactivation of the at least one point-of-interest record is based, at least in part, on one or more temporal parameters (e.g., one or more operating times, one or more availability times, one or more reservation times, or a combination thereof), one or more location parameters (e.g., one or more locations, one or more routes presenting the at least one point-of-interest record, one or more predefined locations, or a combination thereof), one or more environmental parameters (e.g., current or future weather conditions), or a combination thereof. In addition, the one or more temporal parameters and the one or more location parameters may be temporary depending on the various other criteria associated with the rules (e.g., an availability of goods to sell, customers, etc.). Further, it is also contemplated that the one or more rules may be based on any additional criteria for determining when, where, and under what conditions a particular point-of-interest record should be activated or deactivated.

In step 303, the point-of-interest platform 103 determines an input from one or more vendors for specifying the one or more rules, the at least one point-of-interest record, or a combination thereof. As previously discussed, it is contemplated that a point of interest is associated with at least one mobile device (e.g., a mobile phone or a tablet). By way of example, a vendor may use a user interface (e.g., a web client, a widget, an application, etc.) of the at least one mobile device (e.g., a mobile phone or a tablet) to specify the one or more rules. The point-of-interest platform 103 can then determine the one or more rules based on a unique ID associated with the point of interest, the at least one mobile device, or a combination thereof, which is stored in a centralized point-of-interest database (e.g., the POI database 109). In particular, the one or more rules may include one or more instructions to activate the POI record an hour before opening of the point of interest and to deactivate the POI record at closing; to deactivate the POI record when all of the goods have been sold; to change the icon, color, or transparency of the POI record on a mapping and/or navigation application for some time after the point of interest has closed; to deactivate the POI record in the rain; etc. More specifically, the vendor can use the user interface to advertise that “Vendor ‘A’ will be at location ‘X’ at ‘Y’ time.”

In addition, the vendor may pre-broadcast a location and hours of operation and/or may advertise the location and the hours of operation of the point of interest while moving throughout a particular area (i.e., enabling a substantially real-time tracking feature). For example, when the vendor (e.g., Vendor “A”) is moving from location “X” to location “Z” the route is being traced by the point-of-interest platform 103 and can be advertised by the point-of-interest platform 103. In particular, the trace may show where the vendor is when he or she is moving (e.g., between location “X” and location “Z”) at different times. The point-of-interest platform 103 can then present the trace of the vendor, the one or more locations along the trace, or a combination thereof as a result of one or more queries. In addition, the vendor may use the user interface of the at least one mobile device to input quantitative and qualitative data regarding his or her offerings (e.g., “Vendor ‘A’ is selling ‘L’, ‘M’, and ‘N’ fish at location ‘X’ and at time ‘Y’, but there are only 2 fish remaining of each type”). In another example use case, the vendor may establish a rule that associates the point-of-interest record with a personal calendar or a status update on a social networking site that includes the anticipated locations and hours of operation of the POI. Further, in one or more embodiments, the municipality or another owner of realty may enable a vendor to reserve or book a particular POI, with or without charge (e.g., location “X” from 12 pm to 1 pm and location “Z” from 2 pm to 4 pm). In particular, the vendor can pay electronically for the activation of the POI. Also, this can be implemented by way of “BUY” button on the user interface and the payment method can be based on any number of electronic payment methods. As a result, the point-of-interest platform 103 can more effectively control the POI activation process.

In step 305, the point-of-interest platform 103 determines a current state, a predicted state, or a combination thereof of the one or more temporal parameters, the one or more location parameters, the one or more environmental parameters, or a combination thereof, wherein the processing of the one or more rules, the activation, the deactivation, or a combination thereof is based, at least in part, on the current state, the predicted state, or a combination thereof. By way of example, the one or more rules may specify that for a particular POI (e.g., a fishermen on foot) the point-of-interest record should only be activated for when and where he is actually fishing based on the assumption, for example, that if fishing is good that day, the fishermen is unlikely to leave that general area. In contrast, the one or more rules may specify that for another POI (e.g., a street musician) the point-of-interest record should be activated for both when and where he or she is performing as well as for when and where he or she may be performing later in the day based on the assumption, for example, that street musicians have to move around from time to time to maximize available customers. Moreover, it is contemplated that the point-of-interest platform 103 can search the various point-of-interest records in the centralized point-of-interest database (e.g., the POI database 109) using one or more logics, general speeds of movement, one or more location proximity algorithms, one or more statistical models, etc. to determine one or more predictions as to when and where a dynamic POI should be activated (e.g., showing not only open shops, but also shops that might open in the near future).

In step 307, the point-of-interest platform 103 causes, at least in part, an association of the one or more rules with the at least one point-of-interest record, wherein the association is specified as at least one field of the at least one point-of-interest record, as metadata associated with the at least one point-of-interest record, or a combination thereof. By way of example, the point-of-interest platform 103 may maintain the at least one point-of-interest record in a centralized database (e.g., the POI database 109). It is contemplated that the association of the rules with the at least one point-of-interest record may enable the point-of-interest platform 103 to build into each point-of-interest record a novel level of intelligence or logic (e.g., when, where, and under what conditions to display and/or make available the point-of-interest record).

In step 309, the point-of-interest platform 103 causes, at least in part, an activation or a deactivation of at least one point-of-interest record. By way of example, the activation of the at least one point-of-interest record may include an advertising, a broadcasting, a making visible, a making searchable, etc. of the at least one point-of-interest record in connection with a mapping and/or navigation application, an augmented reality application, a social networking application, etc.

FIG. 4 depicts a process 400 of processing and/or facilitating a processing of the one or more rules for the activation or the deactivation of at least one point-of-interest record. In one embodiment, the point-of-interest platform 103 performs the process 400 and is implemented in, for instance, a chip set including a processor and a memory as shown in FIG. 8. In step 401, the point-of-interest platform 103 determines whether to cause, at least in part, a generation of the at least one point-of-interest record based, at least in part, on the activation or the deactivation. As previously discussed, the point-of-interest platform may generate the at least one point-of-interest record based on at least one request, as an update to one or more applications, or a combination thereof. More specifically, the activation of the at least one point-of-interest record may occur in advance of a request (e.g., an update of the mapping and/or navigation application), in response to at least one request, or a combination thereof. In addition, the point-of-interest platform 103 may take into consideration degrees of payment from the one or more vendors to determine a frequency of publication, a degree of search engine optimization, a size or a prominence of a point-of-interest record in a mapping and/or navigation application, for example.

In step 403, the point-of-interest platform 103 determines at least one request for the at least one point-of-interest record. By way of example, a tourist may be exploring unfamiliar area using a mapping and/or navigation application on his or her mobile device (e.g., a mobile phone or a tablet) and he or she may want to find something to eat or some entertainment. Accordingly, the tourist may input one or more keywords typically associated with fixed location POIs (e.g., “fresh fish,” “music,” “restaurants,” etc.) into a mobile search engine or a mapping and/or navigation application of his or her mobile device.

In step 405, the point-of-interest platform 103 determines contextual information associated with the one or more devices, one or more points of interest associated with the at least one point-of-interest record, or a combination thereof, wherein the one or more rules, the processing of the one or more rules, or a combination thereof is further based, at least in part, on the contextual information. By way of example, to ensure relevant results, the point-of-interest platform 103 may determine both a geographic location as well as the subject matter of the request. For example, if the tourist is hungry for a hotdog or pretzel, the point-of-interest platform 103 can determine contextual information both in terms of location and subject matter to present to the tourist on his or her mapping and/or navigation application the most relevant POIs (e.g., a hot dog stand) in the area, at that time.

In step 407, the point-of-interest platform 103 processes and/or facilitates a processing of the one or more rules to cause, at least in part, the generation of the at least one point-of-interest record. More specifically, in step 409, the point-of-interest platform 103 determines one or more rendering characteristics associated with the generation of the at least one point-of-interest record based, at least in part, on the contextual information, the one or more rules, user input, or a combination thereof. By way of example, the point-of-interest platform 103 may attempt to “match” information associated with a point-of-interest record in the centralized point-of-interest database (e.g., the POI database 109) with the requested information based, at least in part, on the one or more rules. If, for example, the system 100 determines a “match,” then the system can present the point-of-interest record (e.g., a name, hours of operation, geo-coordinates, goods and/or services offered, consumer records etc.) on or as part of a mapping and/or navigation application (e.g., as an update to the mapping and/or navigation application), an augmented reality application, a social networking application, etc. so that a user is readily able to find the requested information. As previously discussed, in certain embodiments, where the one or more mobile device lack a mapping and/or navigation application, for example, the point-of-interest platform 103 may advertise the point-of-interest record information via one or more text messaging processes (e.g., SMS, MMS, or a combination thereof). In addition, the point-of-interest platform 103 may only present the most essential point-of-interest record information (e.g., hours of operation, location, and goods and/or services offered) in response to a particular request. In another embodiment, the point-of-interest platform 103 may compare the closing time of the point-of-interest record against a device clock (e.g., of the at least one mobile device) to present one or more point-of-interest records responsive to a request, but already closed for the day, as a different icon, color, level of transparency, etc. so that the requesting customer may know to come back to the POI during hours of operation. Further, in one or more embodiments, the one or more vendors may have excess goods (e.g., excess fish) and/or capacity (e.g., too few customers at a pop-up hairdresser), and therefore may wish to emphasize an availability of discounts associated with a point-of-interest record.

In step 411, the point-of-interest platform 103 determines one or more subscribing user devices associated with the at least one point-of-interest record. By way of example, the presentation of the information associated with a point-of-interest record may occur as part of a scheduled event (e.g., one or more subscriptions to a social networking service). Then in step 413, the point-of-interest platform 103 causes, at least in part, a transmission of one or more messages associated with the activation or the deactivation of the at least one point-of-interest record to the one or more subscribing user devices. Moreover, the point-of-interest platform 103 may obtain access to one or more credentials (e.g., a username and a password) associated with a subscription from the centralized point-of-interest database (e.g., the POI database 109).

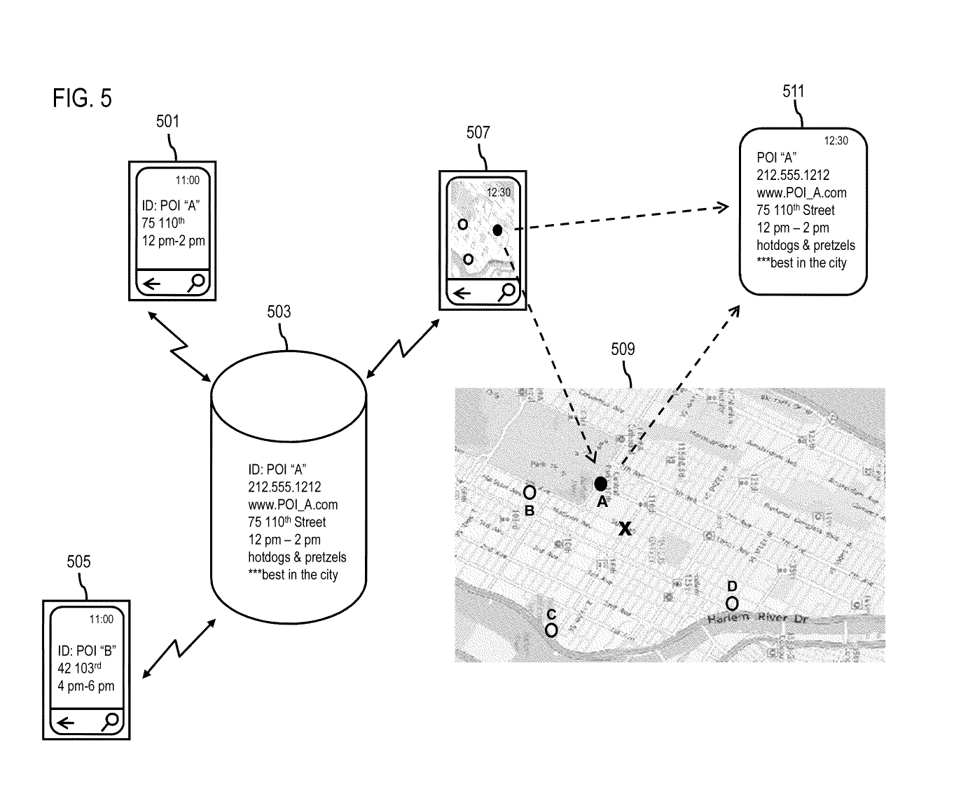

FIG. 5 is a diagram of an example data flow as utilized in the processes of FIGS. 3 and 4, according to various embodiments. As shown, FIG. 5 illustrates an embodiment of one or more vendors inputting one or more rules, at least one point-of-interest record, or a combination thereof associated with one or more points of interest (e.g., a hot dog stand) and at least one request for the at least one point-of-interest record (e.g., a lunchtime hot dog). By way of example, a vendor (e.g., Vendor “A”) at 11:00 am inputs a unique ID (e.g., “POI ‘A’”) and information associated with a point of interest into a mobile device 501 (e.g., a mobile phone or a tablet) that corresponds to a unique ID stored in a centralized point-of-interest database 503 (e.g., a POI database 109). In this example use case, Vendor “A” is pre-broadcasting the anticipated location (e.g., “75 110^{th} street”) and anticipated hours of operation (e.g., 12 pm-2 pm) of his or her point of interest (e.g., a hot dog stand). At the same time, another vendor (e.g., Vendor “B”) uses a mobile device 505 to input a unique ID (e.g., “POI ‘B’”) and information associated with a point of interest (e.g., “42 103^{rd} street” and “4 pm-6 pm”) into the point-of-interest database 503. The system 100 determines based on the unique ID “POI ‘A’” that Vendor “A” has previously input information associated with the point-of-interest record (e.g., contact information, goods and/or services, customer reviews, icon, etc.) into the point-of-interest database 503, as depicted in the diagram.

In one example use case, at 12:30 pm, a tourist, for example, determines he or she is hungry and is looking for a quick bite to eat. Therefore, the tourist inputs “hot dogs” into the search function of a mapping and/or navigation application of his or her mobile device 507 (e.g., a mobile phone). In one embodiment, the system 100 first determines at least one request (e.g., from mobile device 507) for the at least one point-of-interest record. To ensure relevant results, the system 100 next determines contextual information associated with the one or more devices (e.g., mobile device 507), one or more points of interest associated with the at least one point-of-interest record (e.g., mobile device 501), or a combination thereof, wherein the one or more rules, the processing of the one or more rules, or a combination thereof is further based, at least in part, on the contextual information. As previously discussed, the system 100 may determine both a geographic location as well as the subject matter of the request to determine the most relevant POIs in that area, at that time.

In one embodiment, based on the one or more rules (e.g., one or more temporal parameters) previously determined by the system 100 for causing an activation or deactivation of the least one point-of-interest record, the system 100 determines to present the point-of-interest record corresponding to “POI ‘A’” on or as part of a mapping and/or navigation application 509 starting at 12 pm or noon so that the user of the mobile device 507 is readily able to find the requested information. More specifically, the point-of-interest record corresponding to “POI ‘A’” indicates that this point of interest is open on or about the requested time period. In addition, the mapping and/or navigation application 509 is also able to depict the full point-of-interest record 511 if the user of the mobile device 507 wants additional information (e.g., contact information, customer reviews, etc.). Alternatively, the system 100 may determine to present only the most essential point-of-interest record information (e.g., hours of operation, location, and goods and/or services offered) depending on the device capabilities of the mobile device 507. In contrast, based on the one or more rules (e.g., one or more temporal parameters determined by the system 100), the system 100 determines to deactivate the point-of-interest record corresponding to “POI ‘B’” at this time because the point-of-interest record associated with “POI ‘B’” indicates that that point of interest will not be open until 4 pm. As a result, it is contemplated that the association of the rules with the at least one point-of-interest record may enable the system 100 to build into each point-of-interest record a novel level of intelligence or logic (e.g., when, where, and under what conditions to display and/or make available the point-of-interest record).

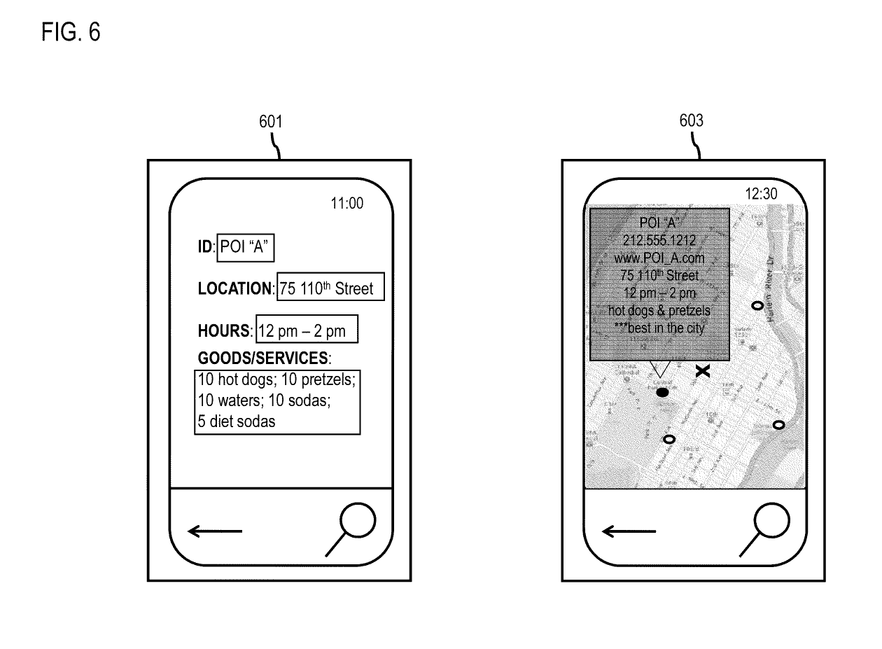

FIG. 6 is a diagram of example user interfaces utilized in the processes in FIGS. 3 and 4, according to various embodiments. As shown, the example user interfaces of FIG. 6 include one or more user interface elements and/or functionalities created and/or modified based, at least in part, on information, data, and/or signals resulting from the processes (e.g., processes 300 and 400) described in FIGS. 3 and 4. More specifically, FIG. 6 illustrates two user interfaces (e.g., interfaces 601 and 603) used in the example use case depicted in FIG. 5. In particular, interface 601 depicts an application (e.g., a web browser) of a mobile device (e.g., a mobile phone) for specifying one or more rules, at least one point-of-interest record, or a combination thereof. By way of example, a vendor (e.g., Vendor “A”) at 11:00 am may input a unique ID that corresponds to a point of interest and a unique ID stored in a point-of-interest database (e.g., the POI database 109), the anticipated location of his or her point of interest (e.g., “75 110^{th} street”), the anticipated hours of operation (e.g., “12 pm-2 pm), the goods and/or services offered including both quantitative and qualitative data, etc. Consequently, interface 603 depicts the results of a request for something to eat (e.g., a hot dog) at 12:30 pm. More specifically, based on the one or more rules (e.g., one or more temporal parameters) determined by the system 100 for causing an activation or deactivation of the least one point-of-interest record, the system 100 determines to present the point-of-interest record corresponding to “POI ‘A’” on or as part of a mapping and/or navigation application in interface 603 starting at 12 pm or noon.

The processes described herein for advertising up-to-date information for dynamic points of interest may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

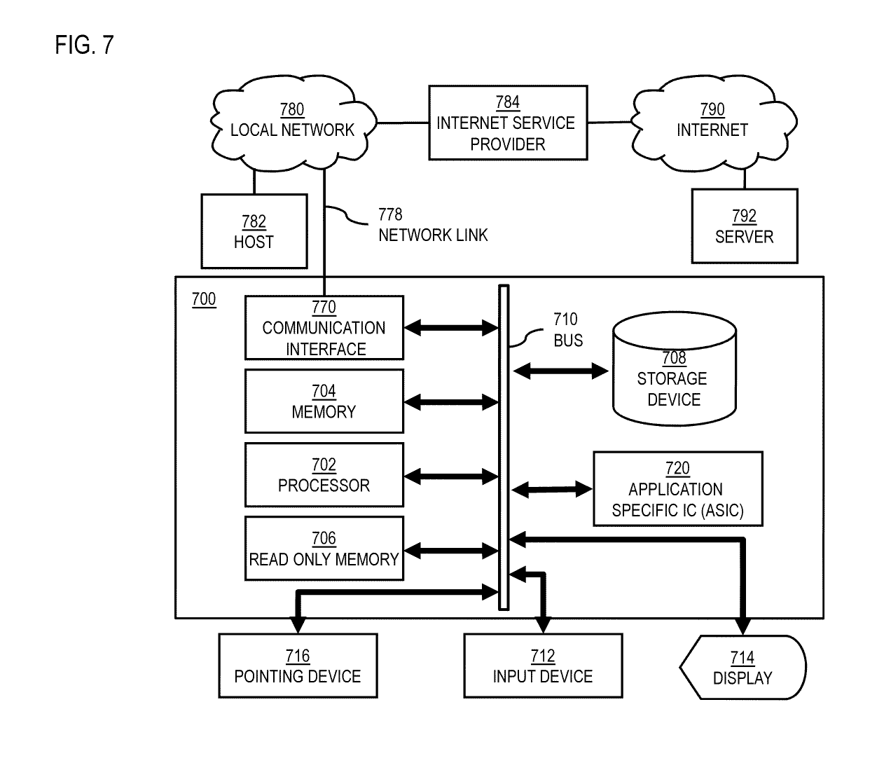

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to advertise up-to-date information for dynamic points of interest as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of advertising up-to-date information for dynamic points of interest.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to advertise up-to-date information for dynamic points of interest. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for advertising up-to-date information for dynamic points of interest. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for advertising up-to-date information for dynamic points of interest, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for advertising up-to-date information for dynamic points of interest to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to advertise up-to-date information for dynamic points of interest as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of advertising up-to-date information for dynamic points of interest.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to advertise up-to-date information for dynamic points of interest. The memory 805 also stores the data associated with or generated by the execution of the inventive steps.

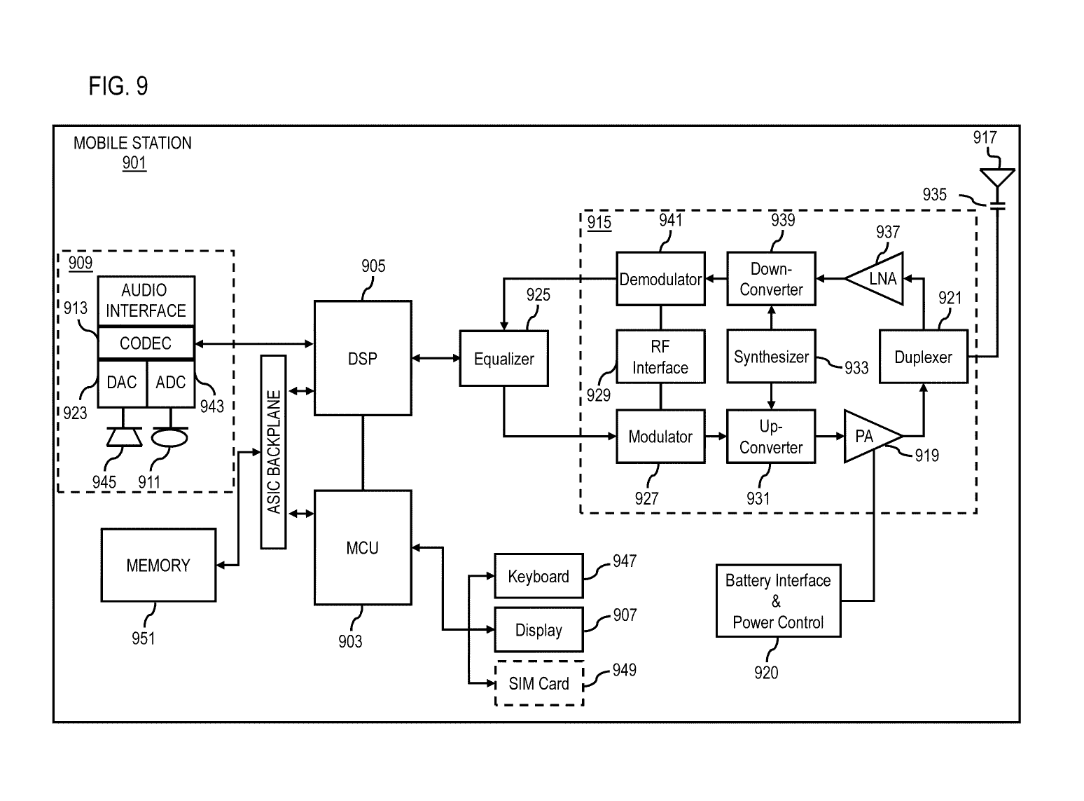

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of advertising up-to-date information for dynamic points of interest. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of advertising up-to-date information for dynamic points of interest. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to advertise up-to-date information for dynamic points of interest. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an activation or a deactivation of at least one point-of-interest record; and
at least one determination of whether to cause, at least in part, a generation of the at least one point-of-interest record based, at least in part, on the activation or the deactivation.

2. A method of claim 1, wherein the (1) data and/or (2) information and/or (3) at least one signal are further based, at least in part, on the following:
at least one determination of one or more rules for the activation or the deactivation of the at least one point-of-interest record; and
a processing of the one or more rules to cause, at least in part, the generation of the at least one point-of-interest record.

3. A method of claim 2, wherein the (1) data and/or (2) information and/or (3) at least one signal are further based, at least in part, on the following:
at least one determination of at least one request for the at least one point-of-interest record from one or more devices; and
at least one determination of contextual information associated with the one or more devices, one or more points of interest associated with the at least one point-of-interest record, or a combination thereof,
wherein the one or more rules, the processing of the one or more rules, or a combination thereof is further based, at least in part, on the contextual information.

4. A method of claim 1, wherein the (1) data and/or (2) information and/or (3) at least one signal are further based, at least in part, on the following:
an association of the one or more rules with the at least one point-of-interest record,
wherein the association is specified as at least one field of the at least one point-of-interest record, as metadata associated with the at least one point-of-interest record, or a combination thereof.

5. A method of claim 1, wherein the one or more rules specify the activation or the deactivation of the at least one point-of-interest record based, at least in part, on one or more temporal parameters, one or more location parameters, one or more environmental parameters, or a combination thereof.

6. A method of claim 5, wherein the (1) data and/or (2) information and/or (3) at least one signal are further based, at least in part, on the following:
at least one determination of a current state, a predicted state, or a combination thereof of the one or more temporal parameters, the one or more location parameters, the one or more environmental parameters, or a combination thereof,
wherein the processing of the one or more rules, the activation, the deactivation, or a combination thereof is based, at least in part, on the current state, the predicted state, or a combination thereof.

7. A method of claim 5, wherein the one or more temporal parameters include, at least in part, one or more operating times, one or more availability times, one or more reservation times, or a combination thereof.

8. A method of claim 6, wherein the one or more location parameters include, at least in part, one or more locations, one or more routes presenting the at least one point-of-interest record, one or more predefined locations, or a combination thereof.

9. A method of claim 3, wherein the (1) data and/or (2) information and/or (3) at least one signal are further based, at least in part, on the following:
at least one determination of one or more rendering characteristics associated with the generation of the at least one point-of-interest record based, at least in part, on the contextual information, the one or more rules, user input, or a combination thereof.

10. A method of claim 1, wherein the (1) data and/or (2) information and/or (3) at least one signal are further based, at least in part, on the following:
at least one determination of one or more subscribing user devices associated with the at least one point-of-interest record; and
a transmission of one or more messages associated with the activation or the deactivation of the at least one point-of-interest record to the one or more subscribing user devices.

11. An apparatus comprising:
at least one processor; and
at least one memory including computer program code for one or more programs,
the at least one memory and the computer program code configured to, with the at least one processor, cause the apparatus to perform at least the following,
cause, at least in part, an activation or a deactivation of at least one point-of-interest record; and
determine whether to cause, at least in part, a generation of the at least one point-of-interest record based, at least in part, on the activation or the deactivation.

12. An apparatus of claim 11, wherein the apparatus is further caused to:
determine one or more rules for the activation or the deactivation of the at least one point-of-interest record; and
process and/or facilitate a processing of the one or more rules to cause, at least in part, the generation of the at least one point-of-interest record.

13. An apparatus of claim 12, wherein the apparatus is further caused to:
determine at least one request for the at least one point-of-interest record from one or more devices; and
determine contextual information associated with the one or more devices, one or more points of interest associated with the at least one point-of-interest record, or a combination thereof,
wherein the one or more rules, the processing of the one or more rules, or a combination thereof is further based, at least in part, on the contextual information.

14. An apparatus of claim 11, wherein the apparatus is further caused to:
cause, at least in part, an association of the one or more rules with the at least one point-of-interest record,
wherein the association is specified as at least one field of the at least one point-of-interest record, as metadata associated with the at least one point-of-interest record, or a combination thereof.

15. An apparatus of claim 11, wherein the one or more rules specify the activation or the deactivation of the at least one point-of-interest record based, at least in part, on one or more temporal parameters, one or more location parameters, one or more environmental parameters, or a combination thereof.

16. An apparatus of claim 15, wherein the apparatus is further caused to:
determine a current state, a predicted state, or a combination thereof of the one or more temporal parameters, the one or more location parameters, the one or more environmental parameters, or a combination thereof,
wherein the processing of the one or more rules, the activation, the deactivation, or a combination thereof is based, at least in part, on the current state, the predicted state, or a combination thereof.

17. An apparatus of claim 15, wherein the one or more temporal parameters include, at least in part, one or more operating times, one or more availability times, one or more reservation times, or a combination thereof.

18. An apparatus of claim 16, wherein the one or more location parameters include, at least in part, one or more locations, one or more routes presenting the at least one point-of-interest record, one or more predefined locations, or a combination thereof.

19. An apparatus of claim 11, wherein the apparatus is further caused to:
determine an input from one or more vendors for specifying the one or more rules, the at least one point-of-interest record, or a combination thereof.

20. An apparatus of claim 11, wherein the apparatus is further caused to:
determine one or more subscribing user devices associated with the at least one point-of-interest record; and
cause, at least in part, a transmission of one or more messages associated with the activation or the deactivation of the at least one point-of-interest record to the one or more subscribing user devices.

21-50. (canceled)
